(19) United States
(12) Patent Application Publication
(10) Pub. No.: US 2008/0259005 A1
(43) Pub. Date: Oct. 23, 2008

(54) DISPLAY PANEL AND ELECTRONIC SYSTEM UTILIZING THE SAME

(75) Inventor: Keiichi Sano, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TPO DISPLAYS CORP., Miao-Li County (TW)

(21) Appl. No.: 11/738,555

(22) Filed: Apr. 23, 2007

(51) Int. Cl. G09G 3/30

(52) U.S. Cl. 345/76

(57) ABSTRACT

A display panel including a first sub-pixel, a second sub-pixel, and a processing unit is disclosed. The first sub-pixel includes a first storage capacitor for storing a first voltage. The second sub-pixel includes a second storage capacitor for storing a second voltage. The processing unit processes the first voltage and transmits the processed result to the first or the second capacitor according to a control signal group.

### BACKGROUND OF THE INVENTION

1. Field of the Invention

The invention relates to a display panel and an electronic system, and more particularly to a low power display panel and an electronic system utilizing the same.

2. Description of the Related Art

Liquid crystal displays (LCD) are widely used, as they possess the favorable advantages of thin profile, light weight, and low radiation. LCDs are frequently utilized in portable devices, such as digital still cameras (DSC), notebook computers, and personal digital assistants (PDA) among others. LCD driving methods include static driving, simple matrix driving, and active matrix driving. Simple matrix driving (also known as passive matrix) comprises a twisted nematic (TN) type and a super twisted nematic (STN) type. Thin film transistors (TFT) are typically utilized in active matrix LCDs.

Because LCDs do not emit light, a backlight, preferably capable of providing high, uniform brightness, is utilized. An LCD typically comprises a source driver for providing data signals to a plurality of sub-pixels. Each sub-pixel comprises a liquid crystal component. A data signal rotates a corresponding liquid crystal component to allow light emitted from backlight to pass through the liquid crystal component. Thus, a pixel displays a gray level. The source driver must continuously provide data signals resulting in excessive power consumption.

### BRIEF SUMMARY OF THE INVENTION

Display panels are provided. An exemplary embodiment of a display panel comprises a first sub-pixel, a second sub-pixel, and a processing unit. The first sub-pixel comprises a first storage capacitor for storing a first voltage. The second sub-pixel comprises a second storage capacitor for storing a second voltage. The processing unit processes the first voltage and transmits the processed result to the first or the second capacitor according to a control signal group.

Electronic systems are also provided. An exemplary embodiment of an electronic system comprises a display panel and a main module. The display panel comprises a first sub-pixel, a second sub-pixel, and a processing unit. The first sub-pixel comprises a first storage capacitor for storing a first voltage. The second sub-pixel comprises a second storage capacitor for storing a second voltage. The processing unit processes the first voltage and transmits the processed result to the first or the second capacitor according to a control signal group. The main module executes associated functions.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an electronic system;

FIG. 2 is a schematic diagram of an exemplary embodiment of a display panel;

FIG. 3 is a schematic diagram of an exemplary embodiment of sub-pixels in a column;

FIG. 4 is a schematic diagram of an exemplary embodiment of a processing unit,

FIG. 5 is a schematic diagram of another exemplary embodiment of a processing unit; and

FIG. 6 is a timing diagram of control signals.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

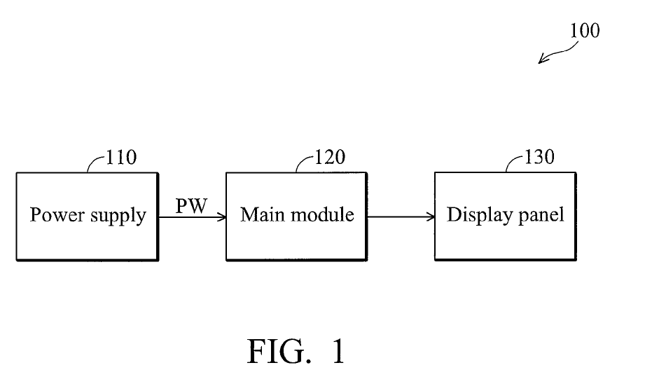

FIG. 1 is a schematic diagram of an exemplary embodiment of an electronic system. The electronic system 100 comprises a power supply 110, a main module 120, and a display panel 130. Power supply 110 is a battery for directly providing power PW. The power PW is a direct current (DC). In some embodiments, power supply 110 is an adapter for transforming an alternating current (AC) power to DC power.

Main module 120 receives the power PW and executes associated functions according to the type of electronic system 100. For example, if electronic system 100 is a mobile phone, main module 120 executes associated communication functions. If electronic system 100 is a PDA, main module 120 executes data processing functions. In some embodiments, electronic system 100 is a NB, a personal computer (PC), or a digital TV.

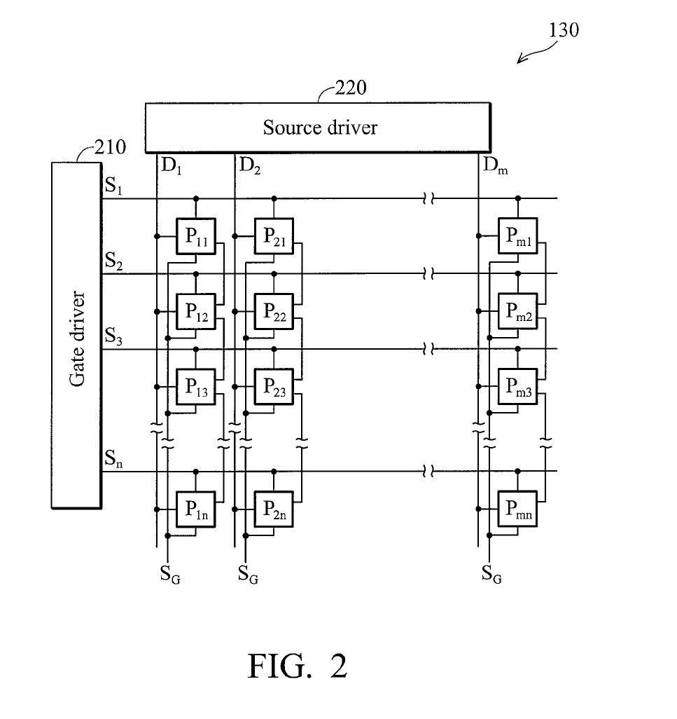

Display panel 130 is controlled by main module 120 for displaying images. FIG. 2 is a schematic diagram of an exemplary embodiment of a display panel. Display panel 130 comprises a gate driver 210, a source driver 220, and sub-pixels P₁₁˜Pₘₙ. Gate driver 210 provides scan signals to sub-pixels P₁₁˜Pₘₙ via scan line S₁˜Sₙ. Source driver 220 provides data signals to sub-pixels P₁₁˜Pₘₙ via data line D₁˜Dₘ. All sub-pixels in a row (one scan line) are turned on or off by one scan signal,thus, data signals are stored in the corresponding sub-pixels. In this embodiment, all sub-pixels in a column (one data line) are controlled by a control signal group S_{G}. In some embodiments, all sub-pixels in a column are respectively controlled by a plurality of control signal groups.

Description of the operation of gate driver 210 and source driver 220 is omitted, as they are well known to those skilled in the art. In this embodiment, data signals control whether light generated by a backlight (not shown) passes through the sub-pixels P₁₁˜Pₘₙ. Additionally, sub-pixels P₁₁˜Pₘₙ can be red (R), green (G), or blue (G). In other words, a single pixel comprises three sub-pixels, R, G, and B.

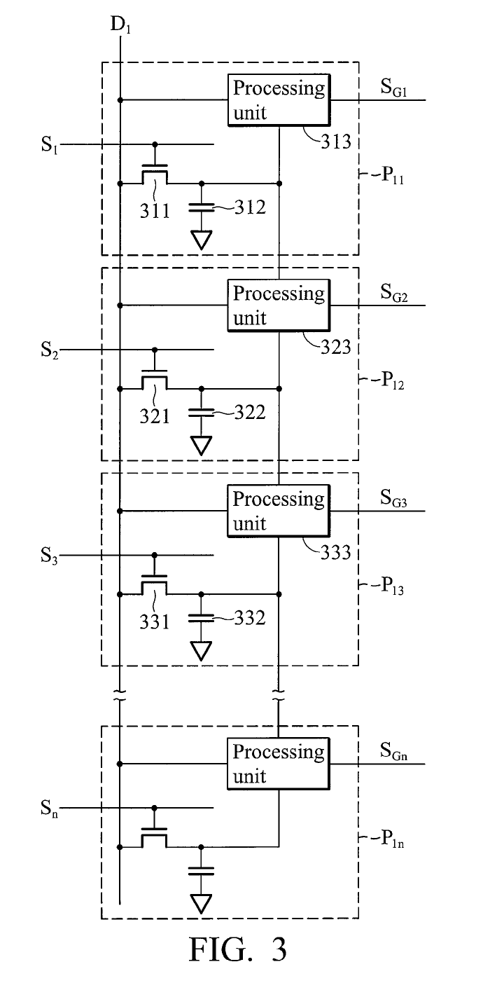

FIG. 3 is a schematic diagram of an exemplary embodiment of sub-pixels in a column. In this embodiment, each sub-pixel comprises a processing unit controlled by a control signal group. In some embodiments, the processing unit does not comprise a sub-pixel and one control signal group controls all processing units. Additionally, a processing unit controls all sub-pixels P₁₁˜Pₘₙ.

Taking sub-pixel P₁₂ as an example, when a transistor 321 is turned on by a scan signal on scan line S₂, a data signal on data line D₁ is transmitted to a storage capacitor 322 via transistor 321. Thus, sub-pixel P₁₂ displays the corresponding brightness. Processing unit 323 processes voltage stored in storage capacitor 322 according to a control signal group S_{G2} and transmits the processed result to storage capacitor 312, 322, or 332.

When display panel 130 desires to display the same images, processing unit 323 stores the processed result in storage capacitor 322. When display panel 130 is required to display imperceptible changes between images, processing unit 323 stores the processed result in storage capacitor 312 or 332 according to control signal group S_{G2}.

Initially, source driver 220 provides original data signals to sub-pixels, the processing unit subsequently processes the original data signals to generate a new data signal and provides the processed result (new data signal) to the corresponding sub-pixel. Because source driver 220 does not repeatedly provide data signals, the power consumption is reduced.

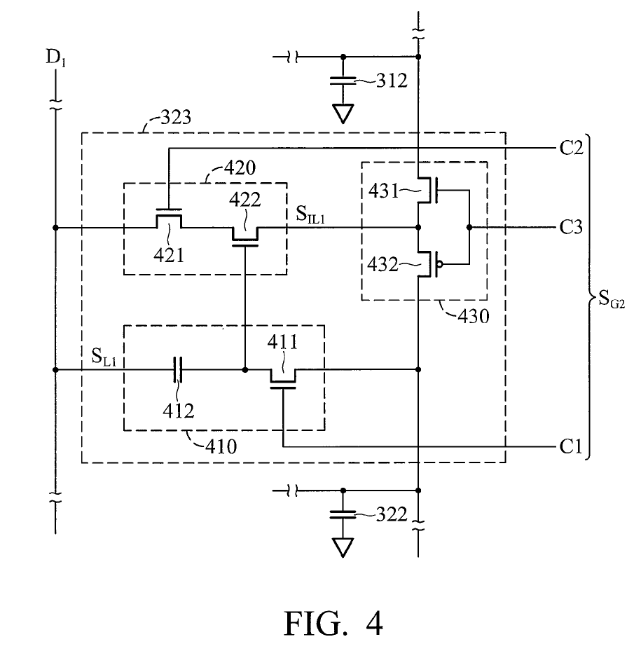

FIG. 4 is a schematic diagram of an exemplary embodiment of a processing unit. Processing unit 323 comprises a sample-hold device 410, an inverter 420, and a control device 430.

Sample-hold device 410 latches voltage stored in storage capacitor 322 to generate a latch signal S_{L1} according to a control signal C1 of the control signal group S_{G2}. In this embodiment, sample-hold device 410 comprises a transistor 411 and a capacitor 412. Transistor 411 is an N type transistor and is connected to capacitor 412 in series between data line D₁ and control device 430.

Inverter 420 inverts the latch signal S_{L1} to generate an inverted signal S_{IL1} according to a control signal C2 of the control signal group S_{G2}. In this embodiment, inverter 420 comprises transistors 421 and 422. Transistors 421 and 422 are N type transistors and connected in series between data line D₁ and control device 430.

Control device 430 transmits the inverted signal S_{IL1} to storage capacitor 312 or 322 according to a control signal C3 of the control signal group S_{G2}. In this embodiment, control device 430 comprises transistor 431 and 432. Transistor 431 is an N type transistor and transistor 432 is a P type transistor.

Because the source and the drain of a transistor are determined according to the direction of the current, the two terminals of the transistor are referred to source/drain and drain/source. Transistor 431 comprises a gate receiving the control signal C3, a drain/source coupled to storage capacitor 312, and a source/drain coupled to inverter 420. Transistor 432 comprises a gate receiving the control signal C3, a drain/source coupled to storage capacitor 322 and sample-hold device 410, and a source/drain coupled to the source/drain of transistor 431.

When the control signal C3 is high, the inverted signal S_{IL1} is transmitted to storage capacitor 312. When the control signal C3 is low, the inverted signal S_{IL1} is transmitted to storage capacitor 322. In this embodiment, the control signals C1 and C2 are the same.

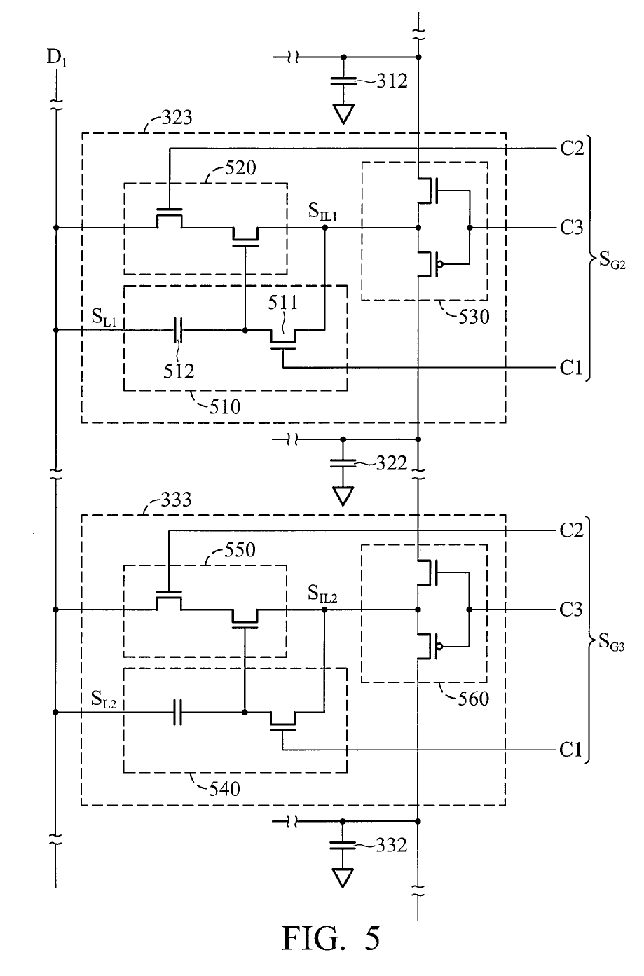

FIG. 5 is a schematic diagram of another exemplary embodiment of a processing unit. FIG. 5 is similar to FIG. 4 with the exception that a sample-hold device 510 directly connects to an inverter 520. Because the operating principle of sample-hold devices 410, 510, and 540 is identical, description of sample-hold devices 510 and 540 is omitted. Because the operating principle of inverters 420, 520, and 550 is identical, description of inverters 520 and 550 is omitted. Because the operating principle of control devices 430, 530, and 560 is identical, description of control devices 530 and 560 is omitted.

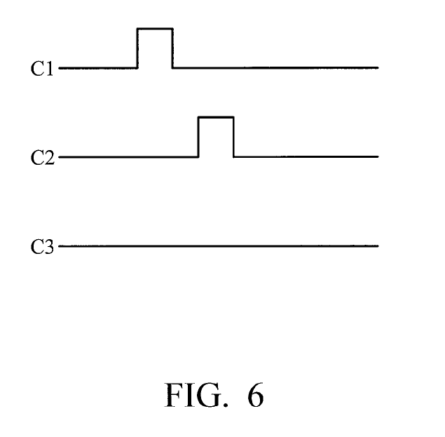

Assuming that the level of one control signal is high or low, the corresponding device is activated or deactivated. FIG. 6 is a timing diagram of control signals. In this embodiment, because control signals C1 and C2 are high with a predetermined sequence and control signal C3 is low, sample-hold device 510 and inverter 520 process voltage stored in storage capacitor 322 for generating an inverted signal S_{IL1}. Additionally, sample-hold device 540 and inverter 550 process voltage stored in storage capacitor 332 for generating an inverted signal S_{IL2}.

Processing unit 323 transmits the inverted signal S_{IL1} to storage capacitor 312, 322, or 332 according to the control signals C1˜C3. Additionally, processing unit 333 transmits the inverted signal S_{IL2} to storage capacitor 322 or 332 or a next storage capacitor (not shown) according to the control signals C1˜C3.

For example, if control signal C3 is continuously low, processing unit 323 transmits the inverted signal S_{IL1} to storage capacitor 322 and processing unit 333 transmits the inverted signal S_{IL2} to storage capacitor 332. If control signal C3 changes from low to high, processing unit 323 transmits the inverted signal S_{IL1} to storage capacitor 312 and processing unit 333 transmits the inverted signal S_{IL2} to storage capacitor 322.

If control signals C1 and C3 are high and control signal C2 is low, sample-hold device 510 receives voltage stored in storage capacitor 312 and sample-hold device 540 receives voltage stored in storage capacitor 322. When control signal C2 are high and control signals C1 and C3 is low, sample-hold device 510 and inverter 520 process voltage stored in storage capacitor 312 to generate the inverted signal S_{IL1} and subsequently stores the inverted signal S_{IL1} in storage capacitor 322. Similarly, sample-hold device 540 and inverter 550, process voltage stored in storage capacitor 322 to generate the inverted signal S_{IL2} and subsequently stores the inverted signal S_{IL2} in storage capacitor 332.

As discussed above, processing unit processes the voltage stored in the corresponding storage capacitor and transmits the processed result to the previous or the next storage capacitor according to the control signal group. For example, processing unit 323 processes the voltage stored in the storage capacitor 322 and transmits the processed result to the previous storage capacitor 312 or the next storage capacitor 332 according to the control signal group S_{G2}.

If the voltage is transmitted to the previous storage capacitor, a last sub-pixel comprising the next storage capacitor is disposed in a non-display region and other sub-pixels are disposed in a display region. The non-display region is not capable of displaying images and the display region is capable of displaying images. Taking FIG. 3 as an example, when the processing unit transmits the processed result to the previous storage capacitor, sub-pixel P₁ₙ is disposed in the non-display region and sub-pixels P₁₁˜P₁₍ₙ₋₁₎ are disposed in the display region. When the processing unit transmits the processed result to the next storage capacitor, sub-pixel P₁₁ is disposed in the non-display region and sub-pixels P₁₂˜P₁ₙ are disposed in the display region. When the processing unit transmits the processed result to the previous or the next storage capacitor, sub-pixels P₁₁ and P₁ₙ are disposed in the non-display region and sub-pixels P₁₂˜P₁₍ₙ₋₁₎ are disposed in the display region.

When imperceptible changes occur between images, the processing unit processes the voltage stored in the corresponding storage capacitor and transmits the processed result to the previous or the next storage capacitor. If the images displayed in the display panel are the same, the processing unit transmits the processed result to the corresponding storage capacitor. The source driver initially provides original data signals to all sub-pixels and the processing unit subsequently processes the original data signals to generate new data signals, thus, power consumption is reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display panel, comprising:
a first sub-pixel comprising a first storage capacitor for storing a first voltage;
a second sub-pixel comprising a second storage capacitor for storing a second voltage; and
a processing unit processing the first voltage and transmitting the processed result to the first or the second capacitor according to a control signal group.

2. The display panel as claimed in claim 1, wherein the first and the second sub-pixels are coupled to a data line.

3. The display panel as claimed in claim 2, wherein the processing unit comprises:
a sample-hold device latching the first voltage to generate a latch signal according to a first control signal of the control signal group;
an inverter inverting the latch signal according to a second control signal of the control signal group; and
a control device storing the inverted signal to the first or the second storage capacitor according to a third control signal of the control signal group.

4. The display panel as claimed in claim 3, wherein the control device comprises:
a first transistor comprising a gate receiving the third control signal, a drain/source coupled to the second storage capacitor, and a source/drain coupled to the inverter; and
a second transistor comprising a gate receiving the third control signal, a drain/source coupled to the first storage capacitor and the sample-hold device, and a source/drain coupled to the source/drain of the first transistor.

5. The display panel as claimed in claim 4, wherein the first transistor is an N type and the second transistor a P type.

6. The display panel as claimed in claim 3, wherein the control device comprises:
a first transistor comprising a gate receiving the third control signal, a drain/source coupled to the second storage capacitor, and a source/drain coupled to the sample-hold device and the inverter; and
a second transistor comprising a gate receiving the third control signal, a drain/source coupled to the first storage capacitor, and a source/drain coupled to the source/drain of the first transistor.

7. The display panel as claimed in claim 6, wherein the first transistor is an N type and the second transistor a P type.

8. The display panel as claimed in claim 6, further comprising a third sub-pixel comprising a third storage capacitor, wherein the processing unit processes the first voltage and stores the processed result to the first, the second or the third storage capacitor according to the control signal group.

9. The display panel as claimed in claim 8, wherein the third sub-pixel is coupled to the data line.

10. The display panel as claimed in claim 9, wherein the first and the second sub-pixels are disposed in a display region, the third sub-pixel is disposed in a non-display region, the display region is capable of displaying image, and the non-display region is incapable of displaying image.

11. An electronic system, comprising:
a display panel comprising:
a first sub-pixel comprising a first storage capacitor for storing a first voltage;
a second sub-pixel comprising a second storage capacitor for storing a second voltage; and
a processing unit processing the first voltage and transmitting the processed result to the first or the second capacitor according to a control signal group; and
a main module executing associated functions.

12. The electronic system as claimed in claim 11, wherein the first and the second sub-pixels are coupled to a data line.

13. The electronic system as claimed in claim 12, wherein the processing unit comprises:
a sample-hold device latching the first voltage to generate a latch signal according to a first control signal of the control signal group;
an inverter inverting the latch signal according to a second control signal of the control signal group; and
a control device storing the inverted signal to the first or the second storage capacitor according to a third control signal of the control signal group.

14. The electronic system as claimed in claim 13, wherein the control device comprises:
a first transistor comprising a gate receiving the third control signal, a drain/source coupled to the second storage capacitor, and a source/drain coupled to the inverter; and
a second transistor comprising a gate receiving the third control signal, a drain/source coupled to the first storage capacitor and the sample-hold device, and a source/drain coupled to the source/drain of the first transistor.

15. The electronic system as claimed in claim 14, wherein the first transistor is N type and the second transistor is P type.

16. The electronic system as claimed in claim 13, wherein the control device comprises:
a first transistor comprising a gate receiving the third control signal, a drain/source coupled to the second storage capacitor, and a source/drain coupled to the sample-hold device and the inverter; and
a second transistor comprising a gate receiving the third control signal, a drain/source coupled to the first storage capacitor, and a source/drain coupled to the source/drain of the first transistor.

17. The electronic system as claimed in claim 16, wherein the first transistor is N type and the second transistor is P type.

18. The electronic system as claimed in claim 16, further comprising a third sub-pixel comprising a third storage capacitor, wherein the processing unit processes the first voltage and stores the processed result to the first, the second or the third storage capacitor according to the control signal group.

19. The electronic system as claimed in claim 18, wherein the third sub-pixel is coupled to the data line.

20. The electronic system as claimed in claim 19, wherein the first and the second sub-pixels are disposed in a display region, the third sub-pixel is disposed in a non-display region, the display region is capable of displaying images, and the non-display region is incapable of displaying images.
